(19) United States
(12) Patent Application Publication
(10) Pub. No.: US 2019/0303628 A1
(43) Pub. Date: Oct. 3, 2019

(54) DEMODULATION METHOD AND DEMODULATION DEVICE FOR MAGNETIC DATA

(71) Applicant: NIDEC SANKYO CORPORATION, Suwa-gun (JP)

(72) Inventor: Kazuto SAEKI, Suwa-gun (JP)

(21) Appl. No.: 16/363,260

(22) Filed: Mar. 25, 2019

(30) Foreign Application Priority Data
Mar. 28, 2018 (JP) 2018-062027

(51) Int. Cl. G06K 7/08

(52) U.S. Cl. CPC G06K 7/087

(57) ABSTRACT

A demodulation method comprising acquiring a series of reversal time intervals corresponding to reversals of magnetization in the magnetic data to store the series of reversal time intervals into a memory; sequentially comparing a first determination reference time with each of the reversal time intervals stored in the memory to generate the demodulated data; determining whether or not the demodulated data is correct; and sequentially comparing, for the series of reversal time intervals stored in the memory, a second determination reference time with the reversal time interval that is a comparison target to generate the demodulated data when it is determined that the demodulated data is not correct at the first determination step. Determination whether or not the time length corresponding to the single bit in the immediately preceding demodulated data is an abnormal value may be performed.

### CROSS REFERENCE TO RELATED APPLICATION

The present application claims priority under 35 U.S.C. § 119 to Japanese Application No. 2018-062027 filed Mar. 28, 2018, the entire content of which is incorporated herein by reference.

### BACKGROUND

### Field of the Invention

At least an embodiment of the present invention relates to a demodulation method for magnetic data for reading the magnetic data recorded in a magnetic recording medium such as a magnetic card to generate demodulated data and a demodulation device for magnetic data.

### Description of the Related Documents

In a magnetic recording medium such as a magnetic card, a bit string including binary bits with a value of “0” or “1” is recorded by using directions of magnetization in a magnetic stripe. FM (frequency modulation) technique is a well-known method for recording bit string data in a magnetic stripe. F2F modulation method is a type of FM technique and defined in an ISO (International Organization for Standardization) standard and the like. In F2F modulation method, recoding is performed in accordance with the following rules:

(a) a direction of magnetization is reversed at a boundary between adjacent bit cells;

(b) a direction of magnetization is not reversed within a bit cell corresponding to “0” (that is, an F signal); and

(c) in a bit cell corresponding to “1”, a direction of magnetization is reversed around a center of the bit cell (that is, a 2F signal),

where a bit cell is a region in the magnetic stripe to be used for recording one bit of data. When a magnetic head is slid with respect to the magnetic stripe to which recording is performed as described above, the magnetic head outputs an analog signal having peaks at positions corresponding to reversals of magnetization. The signal output by the magnetic head is supplied to a peak detection circuit including a differentiating circuit and the like, and then the output from the peak detection circuit is send to a comparator to binarize the output. As a result, an F2Fsignal can be obtained as a binary signal including binary values having either one of two values (high level and low level) in accordance with the directions of magnetization in the magnetic stripe. Demodulation to restore an original bit string composed of “0” and “1” can be performed by comparing the time interval between reversals of level in the F2Fsignal with a time corresponding to the length of a bit cell. A reversal of level means a transition from low to high and a transition from high to low in F2F signal level. Further, “reversal time interval” is also referred to as “interval”. A bit with a value of “0” corresponds to a single reversal time interval having a length equal to the length of the bit cell, while a bit with a value of “1” corresponds to two reversal time intervals, each having a length that is approximately one-half the length of the bit cell.

Upon the demodulation, for example, a value obtained by multiplying the bit cell length by a predetermined timing coefficient is used as a determination reference time. When a reversal in an F2Fsignal is observed, F2Fsignal level is read at a time point after the lapse of the determination reference time from the time point of the reversal. If the F2F signal level at the first reversal is equal to the F2Fsignal level at the time point after the lapse of determination reference time, in other words, the reversal time interval beginning with the reversal is longer than the determination reference time, then the value of the bit is determined as “0”. If a reversal in the signal level is observed at the time point after the lapse of determination reference time, in other words, the reversal time interval beginning with the reversal is shorter than the determination reference time, then the value of the bit is determined as “1”. It is possible to demodulate data sequentially read from a magnetic recording medium by performing such determination sequentially.

The length of a single bit of recorded data in the read magnetic data, i.e., bit cell length, is ideally constant, but often fluctuates due to variation in conveying speed when a magnetic recording medium is conveyed for writing or reading, or noise. In order to suppress influence from fluctuation in the bit cell length and achieve correct demodulation of data read from a magnetic recording medium, Japanese Unexamined Patent Application Publication No. 2013-45471 discloses reading an F2Fsignal to acquire and store, in a memory, a series of reversal time intervals in the F2Fsignal, thereafter using a first determination reference time for each reversal time interval to demodulate the data, and if it is determined that the resulting demodulated data has an error by using a parity check or a data length check, performing demodulation by using a second determination reference time for each reversal time interval stored in the memory, and if it is still determined that the resulting demodulated data has an error, further performing demodulation by using a third determination reference time, or a fourth determination reference time. The first determination reference time used is a value obtained by multiplying a theoretical bit cell length by a predetermined determination timing coefficient α (for example, 0.707), and such a modulation method based on a fixed determination reference time can be referred to as a fixed sampling method. A value obtained by multiplying a bit cell length of a single bit immediately preceding a bit cell that is a target to be determined by the determination timing coefficient α is used as a second determination reference time. The length of the immediately preceding bit cell is obtained from a reversal time interval stored in the memory and based on the measured value. The third determination reference time is a value obtained by multiplying a bit cell length, that is an arithmetic mean of bit cell lengths of immediately preceding two bit cells, by a predetermined determination timing coefficient a, and based on the arithmetic mean of bit cell lengths of immediately preceding two bit cells. The fourth determination reference time is a value obtained by multiplying a predetermined determination timing coefficient α by the sum of two third of the cell bit length of the immediately preceding single bit and one third of the cell bit length of a bit preceding by two bits from a bit cell that is a target to be determined, and based on the values obtained by performing weighting for two immediately preceding bits. The demodulation by using the second, third, and fourth determination reference times each depend on the bit cell length of the immediately preceding bit, and thus classified into a bit tracking sampling method.

Japanese Unexamined Patent Application Publication (Translation of PCT Application) No. H4−504480 discloses demodulating magnetic data by using reversal time intervals in a binary F2Fsignal based on the above-described fixed sampling method, in which a parameter corresponding to the determination timing coefficient α is changed in accordance with a variation pattern of a waveform of an analog signal output from a magnetic head. Furthermore, Japanese Unexamined Patent Application Publication No. 2000-293961 discloses demodulating an F2Fsignal, in which an F2Fsignal is stored in a memory, and the demodulation is performed in both the forward direction and the backward direction on the time axis for the F2Fsignal stored in the memory.

In the bit tracking sampling method in which demodulated data is generated based on data of one or two immediately preceding bits, if the data content of the immediately preceding bit(s) is abnormal, then demodulated data for the next bit is generated by using the abnormal data. As a result, demodulation may be failed due to failing in determination whether the value of the bit is “0” or “1”.

At least an embodiment of the present invention provides a demodulation method and demodulation device allowing for demodulation not requiring rereading from a magnetic recording medium, even if data of an immediately preceding bit is abnormal.

### SUMMARY

A demodulation method according to at least an embodiment of the present invention is a demodulation method for reading, by a magnetic head, magnetic data recorded in a magnetic recording medium to generate demodulated data, including, acquiring a series of reversal time intervals corresponding to reversals of magnetization in the magnetic data to store the series of reversal time intervals into a memory, a first demodulation step for sequentially comparing a first determination reference time with each of the reversal time intervals stored in the memory to generate the demodulated data, the first determination reference time being obtained by multiplying a theoretical time length corresponding to a single bit by a determination timing coefficient, the theoretical time length corresponding to a single bit being defined based on conveying speed of the magnetic recording medium and recording density in the magnetic recording medium, a first determination step for determining whether or not the demodulated data acquired in the first demodulation step is correct, and a second demodulation step for sequentially comparing, for the series of reversal time intervals stored in the memory, a second determination reference time with the reversal time interval that is a comparison target to generate the demodulated data when it is determined that the demodulated data is not correct at the first determination step, the second determination reference time being obtained by multiplying the determination timing coefficient by a time length updated with a time length corresponding to a single bit in a demodulated data immediately preceding in relation to the reversal time interval that is the comparison target, and, in the second demodulation step, determination whether or not the time length corresponding to the single bit in the immediately preceding demodulated data is an abnormal value is performed, and if it is determined that the time length is an abnormal value, then the updating of the time length is not performed.

A demodulation device for magnetic data according to at least an embodiment of the present invention is a demodulation device for generating demodulated data from magnetic data recorded in a magnetic recording medium, including a magnetic head configured to read the magnetic data from the magnetic recording medium, a memory, and a demodulation unit configured to acquire a series of reversal time intervals corresponding to reversals of magnetization in the magnetic data to store the series of reversal time intervals into a memory, and perform a first demodulation processing, a first determination processing, and a second demodulation processing, the first demodulation processing being for sequentially comparing a first determination reference time with each of the reversal time intervals stored in the memory to generate the demodulated data, the first determination reference time being obtained by multiplying a theoretical time length corresponding to a single bit by a determination timing coefficient, the theoretical time length corresponding to a single bit being defined based on conveying speed of the magnetic recording medium and recording density in the magnetic recording medium, the first determination processing being for determining whether or not the demodulated data acquired in the first demodulation processing is correct, the second demodulation processing being for sequentially comparing, for the series of reversal time intervals stored in the memory, a second determination reference time with the reversal time interval that is a comparison target to generate the demodulated data when it is determined that the demodulated data is not correct at the first determination processing, the second determination reference time being obtained by multiplying the determination timing coefficient by a time length updated with a time length corresponding to a single bit in a demodulated data immediately preceding in relation to the reversal time interval that is the comparison target, and in the second demodulation processing, the demodulation unit determines whether or not the time length corresponding to the single bit in the immediately preceding demodulated data is an abnormal value, and if the demodulation unit determines that the time length is an abnormal value, then the updating of the time length is not performed.

In at least an embodiment of the present invention, if it is determined that demodulated data generated by the fixed sampling method is not correct, demodulated data is generated by using the bit tracking sampling method. In the bit tracking sampling method, demodulation is performed by comparing the reversal time interval that is a comparison target with the second determination reference time on the basis of a time length updated with a time length corresponding to a single bit in a demodulated data immediately preceding in relation to the reversal time interval that is the comparison target. Further, in that demodulation, determination whether or not the time length corresponding to the single bit in the immediately preceding demodulated data is an abnormal value is performed, and if it is determined that the time length is an abnormal value, then the updating of the time length is not performed. In other words, if it is determined that the time length of the immediately preceding single bit (that is, bit cell length) is abnormal, then the determination reference time is not updated and a determination reference time on the basis of a time length of a closest bit determined as a normal bit, such as the bit preceding by two bits in relation to the comparison target, is used. As a result, demodulation for a subsequent bit cannot be affected by the bit cell determined as an abnormal bit cell.

In at least an embodiment of the present invention, if a change in the time length corresponding to the single bit does not fall in a range of −40% to +40% of a closest time length corresponding to a single bit determined as a normal value, the time length may be determined as the abnormal value. The determination criteria of abnormal value defined by the above-described manner allows for secure detection of abnormal bit cell.

In at least an embodiment of the present invention, in at least one of the first demodulation step and the second demodulation step, demodulation of the series of reversal time intervals is performed in a first time direction to generate the demodulated data, and if the demodulated data generated by the demodulation in the first direction is not correct, demodulation in a second direction which is a direction opposite to the first direction may be performed to generate the demodulated data. Even if demodulation in the forward direction is failed, there may be a case in which demodulation in the backward direction is successfully performed. Thus, it is possible to increase the possibility of finally obtaining demodulated data.

Further, at least an embodiment of the present invention includes a second determination step for determining whether or not the demodulated data acquired in the second demodulation step is correct when the second demodulation step is performed, and if it is determined that the demodulated data is not correct at the second determination step, the first demodulation step and the second demodulation step are repeated with a different determination timing coefficient. Changing the determination timing coefficient allows for further increasing the possibility of obtaining demodulated data by performing reading once. Here, during the first performances of the first demodulation step and the second demodulation step, the determination timing coefficient used is set to 70.7%, and when the first determination step and the second determination step are repeated with a different determination timing coefficient, determination timing coefficients greater than 50% and less than 100% are used such that a determination timing coefficient greater than 70.7% and a determination timing coefficient less than 70.7% are alternately used. As a result, it is possible to reduce the number of repetitions for obtaining demodulated data.

At least an embodiment of the present invention allows for demodulation not requiring rereading from a magnetic recording medium, even if it is determined that data of an immediately preceding bit is abnormal.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a configuration of a demodulation device according to an embodiment of the present invention;

FIGS. 2A and FIG. 2B are a timing chart for describing sampling methods;

FIG. 3 is a flowchart illustrating processes in a bit tracking sampling method; and

FIG. 4 is a flowchart illustrating a demodulation processing by using a demodulation device.

### DETAILED DESCRIPTION

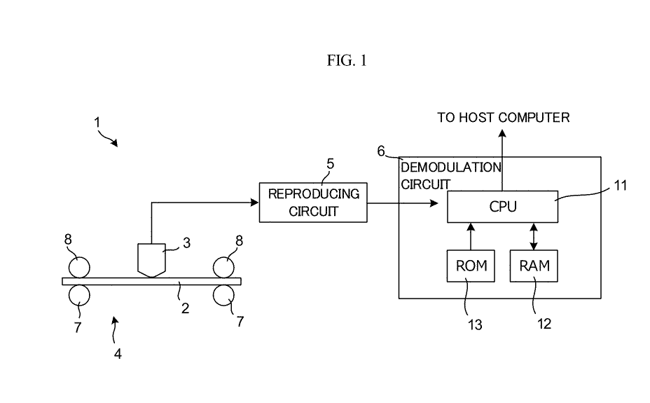

With reference to the drawings, an embodiment of the present invention will be described. The demodulation device 1 illustrated in FIG. 1 is a device configured to read magnetic data recorded in a magnetic card 2, that is a magnetic information medium, and generate demodulated data to output the demodulated data to a host device such as a host computer. An example of the demodulation device 1 is a card conveying type card reader configured to perform reading while conveying the magnetic card 2. In the present embodiment, it is assumed that the magnetic data is recorded in the magnetic card 2 by using F2F modulation method. The magnetic card 2 is a rectangular card made of vinyl chloride and has a thickness of about 0.7 to 0.8 mm, for example. The magnetic card 2 includes a magnetic stripe formed thereon, and magnetic data is recorded in the magnetic stripe. It is noted that the magnetic card 2 may include an IC chip fixed therein or a built-in antenna for data communication. The magnetic card 2 may be a PET (polyethylene terephthalate) card having a thickness of about 0.18 to 0.36 mm, a paper card having a given thickness, or the like.

The demodulation device 1 includes a magnetic head 3 configured to read magnetic data recorded in the magnetic card 2, a conveying mechanism 4 configured to convey the magnetic card 2, a reproducing circuit 5 configured to receive the signal read by the magnetic head 3 and output an F2Fsignal S that is a binary signal, and a demodulation circuit 6 configured to receive the F2Fsignal S and serve as a data demodulation unit. The conveying mechanism 4 includes a driven roller 7 configured to contact with the magnetic card 2 to convey the magnetic card 2. In the illustrated example, the driven rollers 7 are provided along the conveying path of the magnetic card 2 and on either side of the magnetic head 3, and the driven roller 7 is coupled to a driving mechanism (not illustrated) for driving the driven roller 7. Pad rollers 8 opposite to the driven rollers 7 are provided and the pad rollers 8 is biased to the driven rollers 7.

The reproducing circuit 5 has a known configuration. The reproducing circuit 5 includes a filter circuit configured to remove noise components from the signal received from the magnetic head 3, an amplifier circuit configured to amplify the output from the filter circuit, a differentiating circuit (or integration circuit) provided in the output of the amplifier circuit, a comparator configured to binarize the output from the differentiating circuit or the integration circuit, and the like. The reproducing circuit 5 generates an F2F signal S, that is a binary signal, from an analog signal (read signal) output from the magnetic head 3.

The demodulation circuit 6 includes a CPU (central processing unit) 11 serving as a demodulation unit, and a RAM (random access memory) 12 and a ROM (read only memory) 13 serving as a storage unit. The demodulation circuit 6 is configured to demodulate the F2Fsignal S output from the reproducing circuit 5 to generate demodulated data corresponding to a bit string written in the magnetic card 2. In particular, the CPU 11 detects reversals in the F2Fsignal S, and acquires time intervals between reversals, i.e., reversal time intervals. The magnetic stripe of the magnetic card 2 includes a plurality of reversals of magnetization positioned along the longitudinal direction of the magnetic stripe, and thus the F2Fsignal S includes a plurality of reversals corresponding to the plurality of reversals of magnetization. The CPU 11 stores, into the RAM 12, the series of reversal time intervals acquired from the magnetic card 2 being conveyed by the conveying mechanism 4. Further, the CPU 11 performs demodulation by using a program pre-stored in the ROM 13 and based on the series of reversal time intervals stored in the RAM 12 to generate demodulated data. The demodulated data generated is send from the CPU 11 to the host computer.

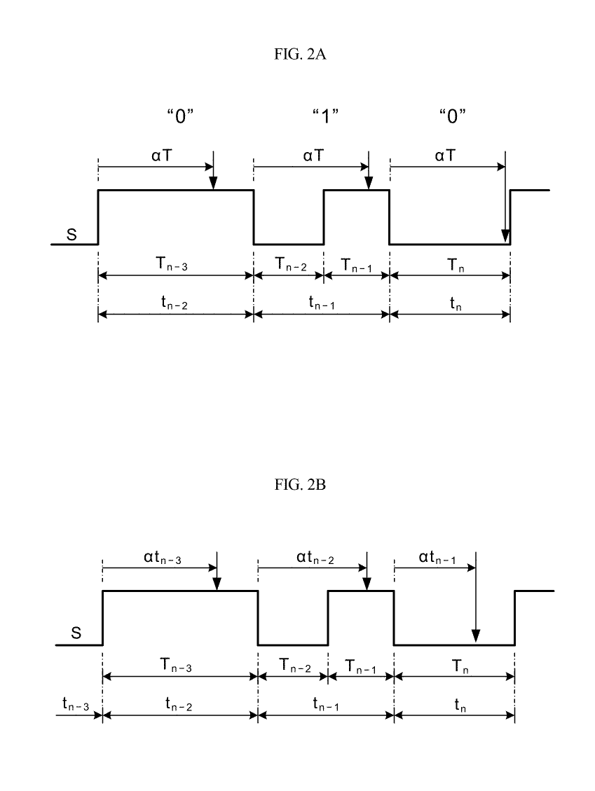

In the demodulation device 1 according to the present embodiment, the demodulation method used is switched between the fixed sampling method and the bit tracking sampling method. Therefore, demodulation by using these sampling methods will be described with reference to FIG. 2A and FIG. 2B. FIG. 2A and FIG. 2B illustrate a case of sampling when an F2Fsignal S corresponding to a bit string “010” recorded in the magnetic card 2 is given. FIG. 2A illustrates the fixed sampling method, while FIG. 2B illustrates the bit tracking sampling method based on an immediately preceding single bit. In these figures, tₙ₋₃ to tₙ each represent a bit cell, and tₙ represents a current bit cell. As illustrated in the figures, the bit cell lengths are not constant. Tₙ₋₃ to Tₙ each represent a reversal time interval, and Tₙ represents a current reversal time interval. T represents a theoretical bit cell length (bit interval) which is defined by the nominal recording density of the magnetic card 2 and the nominal conveying speed of the magnetic card 2. α is a determination timing coefficient (threshold value) and set so as to satisfy 0.5<α<1. Typically, a is set to the square root of 0.5, i.e., 0.707 such that 0.5, α, and 1 constitute a geometric sequence.

A demodulation device disclosed in Japanese Unexamined Patent Application Publication No. 2013-45471 also employs switching between the fixed sampling method and the bit tracking sampling method, but the determination timing coefficient α itself is a fixed value. When the determination timing coefficient α is a fixed value, if the conveying speed of the magnetic card 2 extremely fluctuates, there may be a case in which demodulation cannot be performed. Thus, in the demodulation device 1 according to the present embodiment, a plurality of values are provided as candidates for the determination timing coefficient α, and if a reading error occurs, a different value is selected from the candidates to change the determination timing coefficient α. As a result, the demodulation device 1 according to the present embodiment can accommodate extreme fluctuation in the conveying speed of the card.

In the fixed sampling method illustrated in FIG. 2A, αT is introduced as the determination reference time, where αT is a value obtained by multiplying the determination timing coefficient α by the theoretical bit cell length Tₙ When demodulation processing for a bit cell finishes, there is a reversal of the F2Fsignal at the end of the bit cell. Thus, comparison between the reversal time interval following the reversal and the determination reference time αT is performed. If the reversal time interval is shorter than the determination reference time αT, then it is determined that the value of the bit is “1” and that the reversal time interval and the next one reversal time interval constitute the current bit cell. Then, the demodulation processing proceeds to determination for the next bit cell. In the illustrated example, on the assumption that determination for the bit cell tₙ₋₂ has finished, the following reversal time interval Tₙ₋₂ is shorter than αT, and thus it is determined that the next bit cell tₙ₋₂ has a value of “1” and that the bit cell tₙ₋₁ is constituted by the reversal time intervals Tₙ₋₂ and Tₙ₋₁. A reversal time interval following the bit cell tₙ₋₁ is the reversal time interval Tₙ, which is longer than the determination reference time αT. Thus, it is determined that the bit cell tₙ has a value of “0” and the bit cell tₙ is constituted by the single reversal time interval Tₙ.

On the other hand, in the bit tracking sampling method illustrated in FIG. 2B, discrimination between a bit with a value of “0” and a bit with a value of “1” is performed by using a processing similar to that in the fixed sampling method, but the bit tracking sampling method is different from the fixed sampling method in that a value obtained by multiplying the determination timing coefficient α by a bit cell length of a single bit immediately preceding a bit cell that is a target to be determined is used as a determination reference time. As illustrated in the figure, when bit determination for the bit cell tₙ₋₁ is performed, αtₙ₋₂ is used as a determination reference time. In the bit tracking sampling method, whenever bit determination for a bit cell is performed, the determination reference time for the next bit cell is updated. Thus, even if data of an immediately preceding bit cell is abnormal, the abnormal data is used for demodulation for the following bit cell. As a result, the bit determination for the next bit cell may be failed. Therefore, in the present embodiment, upon generating demodulated data for a bit cell by using the bit tracking sampling method, comparison between the length of that bit cell and a length of a bit cell closest to that bit cell out of bit cells determined as a normal bit cell is performed. If a significant change in bit cell length is detected in the comparison, then it is determined that an abnormal bit cell is detected and updating of the determination reference time based on the bit cell length determined as an abnormal bit cell is not performed.

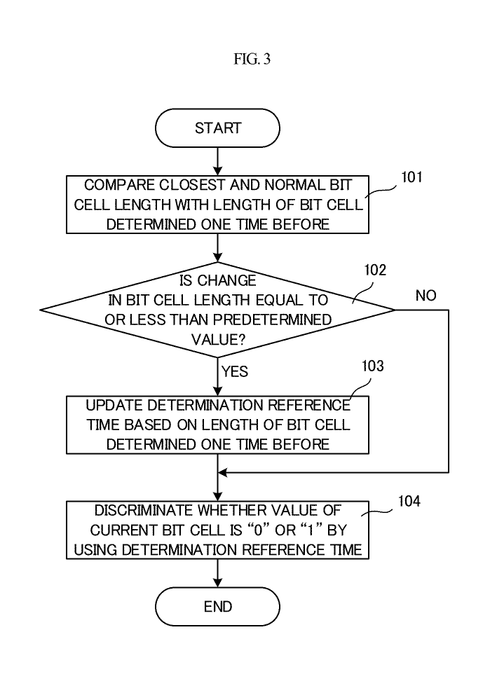

FIG. 3 illustrates processes in the bit tracking sampling method according to the present embodiment. When bit discrimination for a certain bit cell (referred to as the current bit cell) is performed, comparison between the length of the closest bit cell determined as a normal bit cell and the length of the bit cell determined one time before, i.e., the length of the immediately preceding bit cell is firstly performed at step 101 to obtain the change in bit cell length. If the bit cell determined two times before, i.e., the bit cell preceding by two bit cells was determined as a normal bit cell, then the closest bit cell determined as a normal bit cell is the bit cell determined two times before. At step 102, it is determined whether or not the change in the length of the bit cell determined one time before, as compared to the length of the closest bit cell determined as a normal bit cell, is equal to or less than a predetermined value. For example, the predetermined value may be a range from −40% to +40%, a range from −30% to +30%, or a range from −20% to +20%. If the change in the length of the bit cell determined one time before is equal to or less than the predetermined value, then, at step 103, the determination reference time is updated based on the length of the bit cell determined one time before. In other words, a value obtained by multiplying the length of the bit cell determined one time before by the determination timing coefficient α is defined as the determination reference time. Then, the processing proceeds to step 104. On the other hand, if the change in the bit cell length is greater than the predetermined value at step 102, then the processing proceeds to step 104 without updating the determination reference time. In other words, updating of the determination reference time based on the length of the bit cell determined one time before is not performed. At step 104, the bit discrimination for the current bit cell is performed by using the determination reference time.

On the assumption that the bit cell determined two times before is normal, in the above-described procedure, if it is determined that the change in the length of the bit cell determined one time before, as compared to the bit cell determined two times before, is small (in other words, the length of the bit cell determined one time before is normal), then the determination reference time is updated based on the length of the bit cell determined one time before, and the bit discrimination for the current bit cell is performed based on the updated determination reference time. In contrast, if there is a significant change in the length of the bit cell determined one time before, as compared to the bit cell determined two times before (in other words, the length of the bit cell determined one time before may be abnormal), then the determination reference time is not updated and the bit discrimination for the current bit cell is performed by using the determination reference time on the basis of the length of the bit cell determined two times before. If the length of the bit cell determined two times before is almost the same as the length of the current bit cell, the determination for the bit cell next to the current bit cell is performed by using the determination reference time on the basis of the length of the current bit cell. As a result, demodulation for a subsequent bit cell cannot be affected by the abnormal bit cell. It is noted that the bit cell determined two times before does not exist for the first bit cell and the second bit cell in the magnetic data, and thus the processings of steps 101 to 104 cannot be performed for these bit cells. However, the determination reference times for the first bit cell and the second bit cell may be defined based on the theoretical value T of bit cell length. Further, the determination reference time for the second bit cell may be defined based on the length of the first bit cell.

Here, the predetermined value used at step 102 in the procedure illustrated in FIG. 3 will be described. The predetermined value is used to determine whether or not there is a significant fluctuation in the length of the bit cell determined one time before as compared to the length of the bit cell determined two times before, i.e., to determine whether or not the length of the bit cell determined one time before is an abnormal value. If the lower limit of the predetermined value is equal to or less than −50%, the determination reference time is updated based on a bit cell length that is one-half or less than the length of the bit cell determined two times before, resulting in increasing the risk of misrecognizing a reversal time interval corresponding to a bit with a value of “1” that is relatively short as a reversal time interval corresponding to a bit with a value of “0” that is relatively long. On the other hand, the upper limit of the predetermined value is greater than 40% results in a bit cell length longer than a length that is 1.4 times the length of the bit cell determined two times before, and thus, if α=70.7%, that is a typical value of a, then the determination reference time becomes longer than the length of the bit cell determined two times before. This means that there is a high risk of skipping one bit cell in the determination process. Accordingly, the predetermined value related to a change in a bit cell length is a range from −40% to +40%.

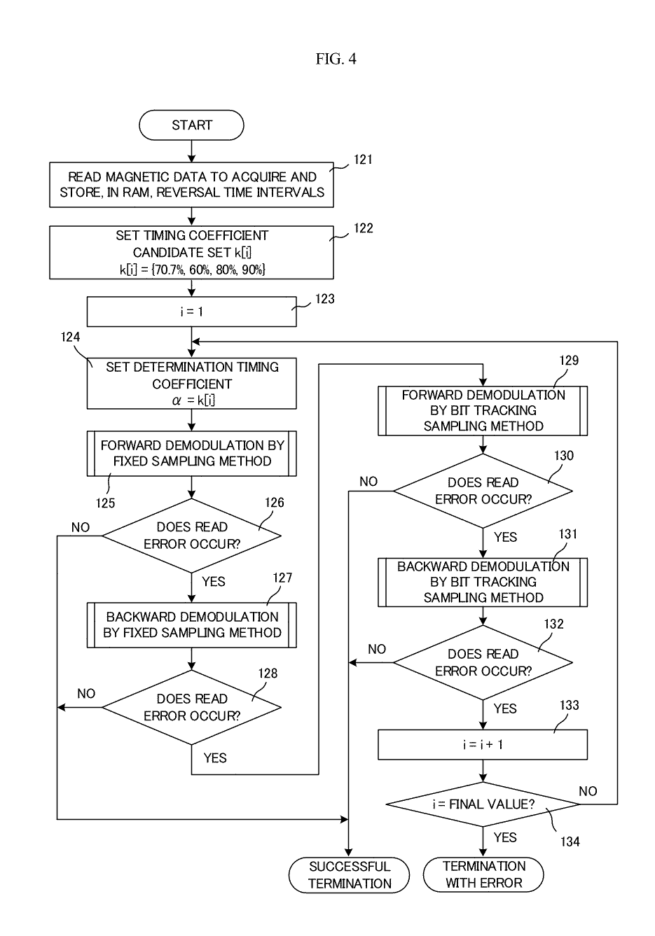

FIG. 4 is a flowchart illustrating a demodulation processing by using a demodulation device 1 according to the present embodiment. Firstly, at step 121, the magnetic head 3 reads magnetic data from the magnetic card 2, the reproducing circuit 5 generates an F2Fsignal S based on a signal from the magnetic head 3, and the CPU 11 acquires reversal time intervals in the F2Fsignal S to store the reversal time intervals into the RAM 12. At step 122, the CPU 11 sets a set k[i] that defines candidates for the determination timing coefficient α and stores the set k[i] into the RAM 12. In the present embodiment, a plurality of values are used as a determination timing coefficient α and the order of priority is set to these values. The value having the highest priority is 70.7%, that is a typical value used as a determination timing coefficient α (in other words, k[1]=70.7%). If the number of coefficients provided is five in total, the coefficients are set and stored in the set k[i] such that the order of coefficients following 70.7% is “60%, 80%, 90%”, for example. If 10 coefficients are provided in total, the coefficients are stored in the set k[i] such that the order of coefficients is “70.7%, 65%, 75%, 60%, 80%, 55%, 90%”, for example. The second and following coefficients are set such that these coefficients form an array of coefficients having a value larger than 70.7% and a value smaller than 70.7% in an alternating manner and the absolute value of the difference between these values and 70.7% gradually becomes greater. However, candidates provided for the determination timing coefficient α are not limited to the above described examples, and any values greater than 50% and less than 100% can be used.

Next, at step 123, the CPU 11 sets an index for the set k[i] to 1 (initial value), and at step 124, the CPU 11 sets the determination timing coefficient α such that α=k[i]. At the first time, i=1, and thus α=70.7%. At step 125, the CPU 11 demodulates a series of reversal time intervals stored in the RAM 12 by using the coefficient α and the fixed sampling method in the forward direction to generate demodulated data. The demodulation in the forward direction means that bit determination for a series of reaction time intervals is performed in accordance with the time order of occurrences of reversal in the F2Fsignal S. At step 126, the CPU 11 verifies whether or not the demodulated data has a predetermined number of bits, whether or not the result of a parity check for each character in the demodulated data is normal, whether or not the result of a parity check for the overall demodulated data is normal, and whether or not the range of each character in the demodulated data is normal, for example, to determine whether or not a read error occurred. If it is determined that a read error did not occurred, the demodulation processing successfully terminates. If the processing successfully terminates, the CPU 11 sends the acquired demodulated data to a host computer, for example.

If, at step 126, it is determined that a read error occurred, then rereading of the magnetic card 2 is not performed, and, at step 127, the CPU 11 performs backward demodulation for the series of reversal time intervals stored in the RAM 12 by using the fixed sampling method and acquires demodulated data. The demodulation in the backward direction means that bit determination for a series of reaction time intervals is performed in accordance with the reverse order of the time order of occurrences of reversal in the F2F signal S. At step 128, the CPU 11 determines whether or not a read error occurs in the demodulated data acquired at step 127, as at step 126. If there is no error, the demodulation processing successfully terminates. If it is determined that an error occurred, then rereading of the magnetic card 2 is not performed, and, at step 129, the CPU 11 performs forward demodulation for the series of reversal time intervals stored in the RAM 12 by using the bit tracking sampling method and acquires demodulated data Then, at step 130, the CPU 11 determines whether or not a read error occurs in the demodulated data, as at step 126. If there is no error, the demodulation processing successfully terminates. If it is determined that an error occurred, then rereading of the magnetic card 2 is not performed, and, at step 131, the CPU 11 performs backward demodulation for the series of reversal time intervals stored in the RAM 12 by using the bit tracking sampling method and acquires demodulated data. Then, at step 132, the CPU 11 determines whether or not a read error occurs in the demodulated data, as at step 126. If there is no error, the demodulation processing successfully terminates.

If it is determined that an error occurred at step 132, then the CPU 11 increments i by 1 at step 133, and at step 134, the CPU 11 determines whether or not i reaches the final value. If i reaches the final value, the demodulation processing terminates with error. If i is not the final value, the CPU 11 repeats the processings at steps 124 to 134 in order to perform demodulation by using a different determination timing coefficient. As a result, demodulation by the fixed sampling method and demodulation by the bit tracking sampling method are repeated with different determination timing coefficients a stored in the set k[i] until the correct demodulated data is acquired. If demodulation of the data is failed despite of such repetition of demodulation, the demodulation processing terminates with error.

### Effect of the Embodiment

The demodulation device 1 according to the present embodiment described above, in which both the fixed sampling method and the bit tracking sampling method are used, can perform demodulation even for magnetic data for which a conventional demodulation method requires repetitive reading. In particular, in the demodulation by using the bit tracking sampling method, a bit cell determined as an abnormal value is not used for calculation of the determination reference time, and thus it is possible to prevent failing of demodulation due to the abnormal bit cell, which otherwise affects the demodulation process for a subsequent bit cell. Therefore it is possible to reduce the read error rate for magnetic data. In addition, the series of reversal time intervals is stored in a memory and demodulation processing is performed for the reversal time intervals stored in the memory, and thus, there is no need for the conveying mechanism 4 to move the magnetic card repeatedly to generate demodulated data. As a result, it is possible to shorten the time required for acquiring demodulated data and to reduce wearing in the magnetic card and the reading device, and thus the lifetime of the magnetic card and the reading device can be extended.

Further, in demodulation by using the fixed sampling method and demodulation by using the bit tracking sampling method in the above-described embodiment, demodulation in the backward direction is performed when a read error occurs in demodulation in the forward direction. Even if demodulation in the forward direction is failed, there may be a case in which demodulation in the backward direction is successfully performed. Thus, it is possible to increase the possibility of finally obtaining demodulated data. In this case, demodulation in the backward direction may be performed firstly and if a read error occurs in the demodulation in the backward direction, then demodulation in the forward direction may be performed. Demodulation in both the forward direction and the backward direction may be performed only in one of the fixed sampling method and the bit tracking sampling method. Further, only one of demodulation in the forward direction and demodulation in the backward direction may be performed in both sampling methods. In addition, in the present embodiment, if a read error occurs in demodulation by the bit tracking sampling method, demodulation by the fixed sampling method and demodulation by using the bit tracking sampling method are repeated with a different determination timing coefficient a until a correct demodulated data is acquired. This approach allows for increasing the possibility of obtaining demodulated data. If recording state of the magnetic data in the magnetic card is excellent, for example, the repetitive demodulation with a different determination timing coefficient α may not be performed.

### Other Embodiments

In the above-described embodiment, a bit tracking sampling method based on an immediately preceding single bit is used as the bit tracking sampling method. However, in at least an embodiment of the present invention, the bit tracking sampling method based on the arithmetic mean of two immediately preceding bits or the bit tracking sampling method based on the values obtained by performing weighting for two immediately preceding bits, as described in Japanese Unexamined Patent Application Publication No. 2013-45471, may be used. Further, in at least an embodiment of the present invention, a combination of various bit tracking sampling methods may be used. This allows for further increasing the possibility of obtaining demodulated data. In addition, in at least an embodiment of the present invention, depending on intended use of demodulated data, it is possible to select: which sampling method is used; whether or not demodulation is performed in both the forward direction and the backward direction; or whether or not demodulation is performed with a different determination timing coefficient a, for example. As a result, it is possible to select the most proper demodulation method depending on the intended use. If highly reliable demodulation or a reliability check for magnetic data is needed (for example, verification of magnetic data written in a magnetic card), demodulation may be performed by using the fixed sampling method in the forward direction with a determination timing coefficient α set to 70.7%, for example, and, in other cases, demodulation may be performed by using the procedure as described with reference to FIG. 4.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A demodulation method for reading, by a magnetic head, magnetic data recorded in a magnetic recording medium to generate demodulated data, comprising:
acquiring a series of reversal time intervals corresponding to reversals of magnetization in the magnetic data to store the series of reversal time intervals into a memory;
a first demodulation step comprising sequentially comparing a first determination reference time with each of the reversal time intervals stored in the memory to generate the demodulated data, the first determination reference time being obtained by multiplying a theoretical time length corresponding to a single bit by a determination timing coefficient, the theoretical time length corresponding to a single bit being defined based on conveying speed of the magnetic recording medium and recording density in the magnetic recording medium;
a first determination step comprising determining whether or not the demodulated data acquired in the first demodulation step is correct; and
a second demodulation step comprising sequentially comparing, for the series of reversal time intervals stored in the memory, a second determination reference time with the reversal time interval that is a comparison target to generate the demodulated data when it is determined that the demodulated data is not correct at the first determination step, the second determination reference time being obtained by multiplying the determination timing coefficient by a time length updated with a time length corresponding to a single bit in a demodulated data immediately preceding in relation to the reversal time interval that is the comparison target, wherein
in the second demodulation step, determination whether or not the time length corresponding to the single bit in the immediately preceding demodulated data is an abnormal value is performed, and if it is determined that the time length is an abnormal value, then the updating of the time length is not performed.

2. The demodulation method according to claim 1, wherein if a change in the time length corresponding to the single bit does not fall in a range of −40% to +40% of a closest time length corresponding to a single bit determined as a normal value, the time length is determined as the abnormal value.

3. The demodulation method according to claim 2, wherein in at least one of the first demodulation step and the second demodulation step, demodulation of the series of reversal time intervals is performed in a first time direction to generate the demodulated data, and if the demodulated data generated by the demodulation in the first direction is not correct, demodulation in a second direction which is a direction opposite to the first direction is performed to generate the demodulated data.

4. The demodulation method according to claim 3, comprising a second determination step comprising determining whether or not the demodulated data acquired in the second demodulation step is correct when the second demodulation step is performed, wherein
if it is determined that the demodulated data is not correct at the second determination step, the first demodulation step and the second demodulation step are repeated with a different determination timing coefficient.

5. The demodulation method according to claim 4, wherein during the first performances of the first demodulation step and the second demodulation step, the determination timing coefficient used is set to 70.7%, and when the first determination step and the second determination step are repeated with a different determination timing coefficient, determination timing coefficients greater than 50% and less than 100% are used such that a determination timing coefficient greater than 70.7% and a determination timing coefficient less than 70.7% are alternately used.

6. The demodulation method according to claim 2, comprising a second determination step comprising determining whether or not the demodulated data acquired in the second demodulation step is correct when the second demodulation step is performed, wherein
if it is determined that the demodulated data is not correct at the second determination step, the first demodulation step and the second demodulation step are repeated with a different determination timing coefficient.

7. The demodulation method according to claim 6, wherein during the first performances of the first demodulation step and the second demodulation step, the determination timing coefficient used is set to 70.7%, and when the first determination step and the second determination step are repeated with a different determination timing coefficient, determination timing coefficients greater than 50% and less than 100% are used such that a determination timing coefficient greater than 70.7% and a determination timing coefficient less than 70.7% are alternately used.

8. The demodulation method according to claim 1, wherein in at least one of the first demodulation step and the second demodulation step, demodulation of the series of reversal time intervals is performed in a first time direction to generate the demodulated data, and if the demodulated data generated by the demodulation in the first direction is not correct, demodulation in a second direction which is a direction opposite to the first direction is performed to generate the demodulated data.

9. The demodulation method according to claim 1, comprising a second determination step comprising determining whether or not the demodulated data acquired in the second demodulation step is correct when the second demodulation step is performed, wherein
if it is determined that the demodulated data is not correct at the second determination step, the first demodulation step and the second demodulation step are repeated with a different determination timing coefficient.

10. The demodulation method according to claim 9, wherein during the first performances of the first demodulation step and the second demodulation step, the determination timing coefficient used is set to 70.7%, and when the first determination step and the second determination step are repeated with a different determination timing coefficient, determination timing coefficients greater than 50% and less than 100% are used such that a determination timing coefficient greater than 70.7% and a determination timing coefficient less than 70.7% are alternately used.

11. A demodulation device for generating demodulated data from magnetic data recorded in a magnetic recording medium, comprising:
a magnetic head configured to read the magnetic data from the magnetic recording medium;
a memory; and
a demodulation unit configured to acquire a series of reversal time intervals corresponding to reversals of magnetization in the magnetic data read from the magnetic recording medium to store the series of reversal time intervals into a memory, and perform a first demodulation processing, a first determination processing, and a second demodulation processing, the first demodulation processing being for sequentially comparing a first determination reference time with each of the reversal time intervals stored in the memory to generate the demodulated data, the first determination reference time being obtained by multiplying a theoretical time length corresponding to a single bit by a determination timing coefficient, the theoretical time length corresponding to a single bit being defined based on conveying speed of the magnetic recording medium and recording density in the magnetic recording medium, the first determination processing being for determining whether or not the demodulated data acquired in the first demodulation processing is correct, the second demodulation processing being for sequentially comparing, for the series of reversal time intervals stored in the memory, a second determination reference time with the reversal time interval that is a comparison target to generate the demodulated data when it is determined that the demodulated data is not correct at the first determination processing, the second determination reference time being obtained by multiplying the determination timing coefficient by a time length updated with a time length corresponding to a single bit in a demodulated data immediately preceding in relation to the reversal time interval that is the comparison target, wherein
in the second demodulation processing, the demodulation unit determines whether or not the time length corresponding to the single bit in the immediately preceding demodulated data is an abnormal value, and if the demodulation unit determines that the time length is an abnormal value, then the updating of the time length is not performed.

12. The demodulation device according to claim 11, wherein if a change in the time length corresponding to the single bit does not fall in a range of −40% to +40% of a closest time length corresponding to a single bit determined as a normal value, the demodulation unit determines that the time length is the abnormal value.

13. The demodulation device according to claim 12, wherein in at least one of the first demodulation processing and the second demodulation processing, the demodulation unit demodulates the series of reversal time intervals in a first time direction to generate the demodulated data, and if the demodulated data generated by the demodulation in the first direction is not correct, the demodulation unit performs demodulation in a second direction which is a direction opposite to the first direction to generate the demodulated data.

14. The demodulation device according to claim 13, wherein the demodulation unit performs a second determination processing for determining whether or not the demodulated data acquired in the second demodulation processing is correct when the second demodulation processing is performed, and
if the demodulation unit determines that the demodulated data is not correct at the second determination processing, the demodulation unit repeats the first demodulation processing and the second demodulation processing with a different determination timing coefficient.

15. The demodulation device according to claim 14, wherein during the first performances of the first demodulation processing and the second demodulation processing, the demodulation unit uses the determination timing coefficient set to 70.7%, and when the first determination processing and the second determination processing are repeated with a different determination timing coefficient, the demodulation unit uses determination timing coefficients greater than 50% and less than 100% such that a determination timing coefficient greater than 70.7% and a determination timing coefficient less than 70.7% are alternately used.

16. The demodulation device according to claim 12, wherein the demodulation unit performs a second determination processing for determining whether or not the demodulated data acquired in the second demodulation processing is correct when the second demodulation processing is performed, and
if the demodulation unit determines that the demodulated data is not correct at the second determination processing, the demodulation unit repeats the first demodulation processing and the second demodulation processing with a different determination timing coefficient.

17. The demodulation device according to claim 16, wherein during the first performances of the first demodulation processing and the second demodulation processing, the demodulation unit uses the determination timing coefficient set to 70.7%, and when the first determination processing and the second determination processing are repeated with a different determination timing coefficient, the demodulation unit uses determination timing coefficients greater than 50% and less than 100% such that a determination timing coefficient greater than 70.7% and a determination timing coefficient less than 70.7% are alternately used.

18. The demodulation device according to claim 11, wherein in at least one of the first demodulation processing and the second demodulation processing, the demodulation unit demodulates the series of reversal time intervals in a first time direction to generate the demodulated data, and if the demodulated data generated by the demodulation in the first direction is not correct, the demodulation unit performs demodulation in a second direction which is a direction opposite to the first direction to generate the demodulated data.

19. The demodulation device according to claim 11, wherein the demodulation unit performs a second determination processing for determining whether or not the demodulated data acquired in the second demodulation processing is correct when the second demodulation processing is performed, and
if the demodulation unit determines that the demodulated data is not correct at the second determination processing, the demodulation unit repeats the first demodulation processing and the second demodulation processing with a different determination timing coefficient.

20. The demodulation device according to claim 19, wherein during the first performances of the first demodulation processing and the second demodulation processing, the demodulation unit uses the determination timing coefficient set to 70.7%, and when the first determination processing and the second determination processing are repeated with a different determination timing coefficient, the demodulation unit uses determination timing coefficients greater than 50% and less than 100% such that a determination timing coefficient greater than 70.7% and a determination timing coefficient less than 70.7% are alternately used.
